(19) United States
(12) Patent Application Publication
(10) Pub. No.: US 2009/0325442 A1
(43) Pub. Date: Dec. 31, 2009

(54) PROCESS FOR PRODUCING AN IN PARTICULAR POROUS SHAPED CERAMIC BODY AND SHAPED BODY PRODUCED THEREBY

(76) Inventors: Reinhard Simon, St. Corona am Wechsel (AT); Robert Danzer, Graz (AT)

Correspondence Address: GREENBLUM & BERNSTEIN, P.L.C., 1950 ROLAND CLARKE PLACE, RESTON, VA, 20191, US

(21) Appl. No.: 12/441,210

(22) PCT Filed: Sep. 13, 2007
(86) PCT No.: PCT/AT07/00434

§ 371 Date: Jul. 2, 2009

(30) Foreign Application Priority Data
Sep. 15, 2006 (AT) A 1529/2006

(51) Int. Cl. D03D 25/00; C04B 38/00

(52) U.S. Cl. 442/181; 501/80

(57) ABSTRACT

The invention relates to a method for producing an in particular porous molded ceramic article, which molded ceramic article is optionally reinforced with fibers and/or a semi-finished textile product such as woven fabric, wherein a powder A and at least one further powder B are suspended in a liquid, after which a molded article is formed from the suspension produced in this manner optionally in combination with fibers and/or a semi-finished textile product and the molded article is optionally sintered. It is provided according to the invention that the powders A and B are suspended approximately at a pH value of the liquid at which a viscosity minimum of the suspension is given, whereby high solids contents in the suspension can be adjusted with low viscosities. This makes possible a rapid production of largely crack-free molded articles with advantageously low-defect structures.

### CROSS-REFERENCE TO RELATED APPLICATIONS

The present application is a U.S. National Stage of International Patent Application No. PCT/AT2007/0004334 filed Sep. 13, 2007, and claims priority of Austrian Patent Application No. A 1529/2006 filed Sep. 14, 2006. Moreover, the disclosure of International Patent Application No. PCT/AT2007/0004334 is expressly incorporated by reference herein in its entirety.

### BACKGROUND OF THE INVENTION

1. Field of the Invention

The invention relates to a method for producing an in particular a porous molded ceramic article, which is optionally reinforced with fibers and/or a semi-finished textile product such as woven fabric. A powder A and at least one further powder B are suspended in a liquid, after which a molded article is formed from the suspension produced. The suspension is optionally produced in combination with fibers and/or a semi-finished textile product and the molded article is optionally sintered.

2. Discussion of Background Information

Furthermore, the subject matter of the invention is a fiber-free, in particular porous molded ceramic article.

Finally, the invention relates to a composite article, comprising an in particular a porous ceramic and fibers and/or a semi-finished textile product such as woven fabric.

In materials technology the development of new materials with customized property profiles has a high priority. For example, a targeted composition of materials of several individual components or materials and/or an introduction of porosity in materials makes it possible to vary the mechanical, electrical, optical and/or magnetic properties thereof. Molded parts and components can thus be adapted in their properties depending on the purpose.

In this context, porous ceramic materials have attracted very considerable attention. Due to a low density, high specific surface area and permeability as well as low thermal conductivity, these materials are suitable for a number of applications, for example, as a catalyst substrate, as a filter for liquid metals or gases, as lightweight components, as bioactive implants or as reinforcing components for composite materials with metals or polymers.

For applications in which porous ceramics are also exposed functionally during use to high mechanical stresses, it is important in terms of method that they can be produced without cracks and with a homogenous structure as far as possible defect-free and that a porosity evenly distributed over the article can be produced in a controllable manner. Inhomogeneities in the structure represent potential weak points during stresses and should therefore not be present.

According to the prior art, for a long time for the production of porous ceramics, methods were relied upon such as introducing organic phases into green compacts and burning out these phases (e.g., U.S. Pat. No. 5,030,396), partial sintering of green compacts produced by means of powder metallurgy (e.g., U.S. Pat. No. 4,218,255), reproduction of polymer foams (e.g., U.S. Pat. No. 5,382,396) or foams of suspensions (e.g., U.S. Pat. No. 4,814,300). These methods are associated with serious disadvantages, in particular inhomogenous pore structures or non-uniform porosity and/or structures impaired by defects and not stable in high-temperature use.

With respect to a porosity that can be adjusted in a controllable manner, progress was made according to the prior art and a method for producing fiber-reinforced, porous ceramic composites was disclosed (DE 103 18 514 B3; R. A. Simon, Progress in Processing and Performance of Porous-matrix Oxide/Oxide Composites, International Journal of Applied Ceramic Technology, 2005, pages 141 through 149; R. A. Simon et al., Kolloidale Herstellung und Eigenschaften einer neuen faserverstärkten Oxidkeramik, Verbundwerkstoffe, Verlag Wiley-VCH, Weinheim, 2003, pages 298 through 303).

In this known method a suspension of compound particles with core-shell structure is produced from two ceramic powders of different grain size (approx. 1 μm or less than 100 nm) at pH=7, after the reduction of the pH value the suspension is processed with fibers to form a green molded article and this molded article is subsequently sintered at a temperature at which only the smaller particles, which are arranged around the larger particles, sinter.

Although a porosity of molded articles can be controlled with this method in the production of porous, fiber-reinforced ceramics, this method nevertheless has substantial disadvantages and limitations, as the inventors recognized:

An accretion of the smaller particles on the larger particles and the formation of a core-shell structure in the suspension is definitely desirable with respect to the porous structure to be formed, but during the suspension of the powders a viscosity of the suspension increases very quickly, which in some cases can lead to the solidification thereof. The powders can therefore be added or suspended with the disadvantage of a large amount of time expended, only very slowly and in many stages, e.g., in stages of 3% of the desired solids content in the suspension.

It is also a disadvantage that due to the solidification problem with the known method only suspensions with a maximum solids content of less than 50% by volume can be produced (DE 103 18 514 B3). This has the following consequences:

Cracks occur during the drying/sintering of the molded articles, since large shrinkages are given because of low solids contents. Pure porous or optionally dense ceramics without fiber-reinforcement cannot be produced for this reason alone, because a dimensional stability or strength of damp, green (i.e., not sintered) molded articles without fiber reinforcement would be too low.

For the same reasons a suspension can be used only for laminating fibers. It cannot be used for other conventional processing processes such as casting or extrusion.

Considered from another point of view, a viscosity is already so great with the solids contents maximally adjustable in the suspension that a complete infiltration is problematic for molded articles with high fiber contents. A fiber content in the solid object is therefore to be restricted to a maximum of 48 percent by volume in order to avoid cavities and/or cracks and/or a defective matrix.

In conclusion, this known method is therefore extremely time-intensive, can lead to the solidification of the suspension, can be used only for lamination processes and can be applied only to produce laminate products with specific fiber content.

### SUMMARY OF THE INVENTION

Based on this prior art, the invention provides a method of the type mentioned at the outset in which the disadvantages set forth above are eliminated or at least reduced and which has an essentially broader application potential.

According to the invention, a fiber-free and, in particular, porous molded ceramic article has a high strength produced from several powders. The fiber free article has a homogenous microstructure with optionally uniform porosity, which can be produced essentially free from cracks.

Further the invention is directed to a high-toughness composite article comprising in particular a porous ceramic and fibers and/or a textile semi-finished product such as woven fabric. The ceramic is produced from several powders, has a homogenous microstructure with optionally uniform porosity and can be produced essentially free from cracks.

According to the invention, a method of the type mentioned at the outset eliminates or at least reduces the disadvantages set forth above in that with a generic method the powders A and B are suspended approximately at a pH value of the liquid at which a viscosity minimum of the suspension is given.

It is advantageous thereby that the problems given in the prior art regarding high viscosities are avoided, because suspension is carried out at the viscosity minimum. Individual components can therefore be suspended in a shorter time, as a rule in 20% or less of the time that is necessary according to the prior art. In addition it has been shown that with this approach an improved deagglomeration above all of powders with small average grain sizes of less than 100 nm occurs, which presumably contributes in a superadditive manner to the achievement of a low viscosity, in particular with high solids contents. As a result of lower viscosities, a risk of solidification during a production of the suspension is also minimized.

Compared to the prior art, according to these advantages it is now possible on the one hand to adjust much higher solids contents in a suspension with the same viscosity. This permits subsequently the processing to fiber-free or fabric-free green molded articles which remain dimensionally stable during drying/sintering even without the use of fibers/textile semi-finished product and can be demolded free from cracks.

On the other hand, with predetermined solids contents lower viscosities of the suspensions are present, which is why these are more suitable for infiltrating textile semi-finished products, and fiber-reinforced ceramic molded articles can also be produced which have more than 50% by volume fibers.

Due to the adjustable high solids contents suspensions can now also be cast or extruded so that in principle all known shaping methods can be used.

The pH value to be maintained during the suspension of the powders can be easily determined by one skilled in the art with sufficient accuracy or approximation, in that a diluted suspension of the powders A and B is produced with e.g., 30 percent by volume solids content and the viscosity of this suspension is determined depending on the pH value.

If fiber-free molded articles are produced, they can be optionally sintered to produce porous or also essentially dense ceramics. The same applies analogously to the ceramic matrix proportion in fiber-reinforced ceramics.

At the same time a multiphase structure with homogenous structure can be achieved through the use of several different powders and thus materials with properties adjusted in a targeted manner can be provided.

The effects achieved can be still further increased in an extremely effective manner when powders are suspended, the zeta potentials of which have the same sign at the adjusted pH value. Unexpectedly, it has been shown that powders A and B, despite zeta potentials with the same sign, form composite particles with core-shell structure, although they should actually repel one another due to the same charge. In contrast thereto in the prior art a formation of composite particles occurs via so-called heterocoagulation, that is the combination of particles with positive and negative zeta potentials, which entails an immediate sharp increase of the viscosity of the suspension during the insertion of the powders due to a high interaction.

When the zeta potentials of powders to be used are not respectively positive or negative, a suitable surface charge can be caused in that in the adjustment of the suspension an additive such as a peptizer or polyelectrolyte is added, which is adsorbed on at least one of the powders.

With many ceramic powders particularly high solids contents can be achieved in the suspension without solidification of the same when the pH value is adjusted to pH<7 and powders A and B are used, the zeta potential of which is positive.

In order to promote a formation of composite particles of the powders A and B in the suspension and thus subsequently the formation of a homogenous structure, it can be provided that an average grain size of the powder A is at least four times that of the powder B. Preferably the powder A has an average grain size of more than 300 nm and the powder B an average grain size of less than 100 nm. It has proven to be favorable thereby that the powder B has a higher zeta potential in terms of amount.

In particular in order to obtain a sintered compact as far as possible free from shrinkage, it can be provided that the volume ratio of powder A to powder B or the powders B is 0.65:0.35 to 0.90:0.10. With these volume ratios of the powders a shrinkage can be minimized, which has a favorable effect on a crack-free embodiment of ceramic components.

A further development of the method according to the invention is also preferred in which during the suspension of the powders the liquid and the powders suspended therein are ground. A very efficient grinding effect is also hereby achieved on agglomerates of powders with (primary) grain sizes of less than 200 nm. This effect is still unexplained. It is presumed that the larger particles exert a grinding effect on the smaller particles and thus break up their agglomerates.

In an alternative variant, which is not quite as effective however, it is also possible that during the suspension of the powders, the liquid and the powders are acted on with ultrasound in order to support a deagglomeration.

According to the advantages of a method according to the invention this is preferably used when a percentage by volume of the powders in the suspension is more than 50% by volume, preferably more than 55% by volume.

The dispersion medium or the liquid is usually water. If one of the powders used reacts with water, it is possible to resort to other liquids that do not react with the powder(s).

It is preferably further provided that a hardener is added to the suspension before the formation of a molded article, which hardener during or after the formation of the molded article supports a coagulation of the particles in the molded article. Preferably the hardener added causes a shift of the pH value towards the isoelectric point and preferably forms a solid reaction product with the liquid. A hardener of this type can be a metal nitride, in particular magnesium nitride, gallium nitride, lanthanum nitride, zirconium nitride, aluminum nitride, yttrium nitride or hafnium nitride. Alternatively, the hardener can also be an organosilicon polymer, in particular polysilazane, polycarbosilazane, polysilasilazane or polysilylcarbodiimide. These hardeners decompose in water while splitting substances changing the pH value and thus ensure a shift of the pH value in the direction of the isoelectric point at which the existing and then neutral composite particles combine due to van der Waals forces so that a solidification occurs. In addition the hardener can also crosslink to a polymer solid and thus also lead to a crosslinking of the powder particles with one another, thus having an action that increases solidification.

If fiber-reinforced ceramics are produced, any two-dimensional or three-dimensional semi-finished textile products, e.g., scrim, braided fabrics, knitted fabrics or knit fabrics can be used. Likewise, a use of short fibers and/or long fibers or also continuous fibers is possible. The fibers/semi-finished products can thereby be coated on the surface with an adhesion promoter before and/or after an infiltration with suspension and thereby adhered or strengthened. For example, organosilicon polymers or various sols, such as metal oxides and solutions of inorganic salts, are suitable for this.

Molded articles according to the invention can be sintered, namely optionally partially as well as completely.

Further, the invention is directed to a molded article of the type described above.

Advantages of a molded article according to the invention are to be seen among other things in an essentially crack-free structure in the green state as well as in the sintered state. At the same time a low-defect or defect-free structure embodiment as well as optionally a uniformly distributed porosity is given.

A porosity can be varied within a broad range, e.g., between 0.05 and 50 percent by volume, depending on the powders used and a sintering temperature. If the aim is for porous molded articles, a porosity is preferably between 30 and 45 percent by volume. Alternatively, molded articles according to the invention can also be embodied essentially densely by corresponding sintering control.

With respect to homogeneity, the molded article thereby advantageously has a structure in which particles of the powder A are largely enveloped by particles of the powder B and firmly connected thereto.

It is furthermore advantageous that a maximum size of defects in the structure is smaller than a maximum grain size. Low defect sizes of this type lead to a disproportionately high strength of the molded article, wherein an increase in strength was observed for green molded articles as well as for sintered molded articles.

In order to avoid shrinkage cracks caused by sintering as far as possible or to keep them low, the volume ratio of the powder A to the powder B or the powders B is 0.65:0.35 to 0.90:0.10. With respect to the adjustment of a homogenous structure it is preferred when the powder A has an average grain size of more than 300 nm and the powder B an average grain size of less than 100 nm.

Moreover, the invention is directed to a composite article of the above-described type.

Advantages of a composite article according to the invention are to be seen in particular in that it has a high fiber content as well as a low-defect matrix and therefore is highly tough and withstands for a long time even in stress situations in which a stability of the matrix is the decisive criterion.

Further advantages, features and effects of the invention are shown by the context of the specification and the following exemplary embodiments.

### BRIEF DESCRIPTION OF THE DRAWINGS

The invention is explained in even more detail below based on only exemplary ways of carrying out the invention and figures. It is obvious to one skilled in the art that individual features of the following examples, even if they are cited in combination with other features, can be connected with the general representation of the invention above.

They show:

FIG. 1: Dependencies of viscosities on dispersions from powders with an average grain size diameter of more than 0.5 μm (“coarse”) and less than 100 nm (“fine”);

FIG. 2: Cast green molded articles;

FIG. 3: A scanning electron microscope image of composite particles in a dried greenbody;

FIG. 4: A scanning electron microscope image of a part of a sintered, porous molded article;

FIG. 5: A cross section of a fiber/ceramic composite part in a ±45° fiber orientation.

### DETAILED DESCRIPTION OF THE INVENTION

### Determination of a Viscosity Minimum of a Suspension, Determination of Zeta Potentials and Determination of Green Strengths

A sufficiently accurate determination of the viscosity minimum of a suspension with high solids content (at 20° C.) can be carried out in that in advance at low solids contents, e.g., 15 to 30 percent by volume, a viscosity is established depending on the pH value or an acid quantity. A production of a suspension of this type with low solids content is unproblematic per se and can be carried out within a short time, optionally with the aid of ultrasound for the deagglomeration. If additives are used, these are proportionally suspended with the powders during a determination of a viscosity minimum. A viscosity of the suspension can then be determined, for example, by rotation viscometry. Subsequently, a pH range in which a viscosity minimum lies is adjusted during the production of a suspension and maintained during a suspension of the powders.

As can be seen from FIG. 1, a viscosity minimum is dependent on the pH value and can also vary with a ratio of fine powder (“fine,” average grain size less than 100 nm) to coarse powder (“coarse,” average grain size greater than 500 nm).

In the examples described below, zeta potentials and particle size distributions of the powders used to produce the suspension were determined for each powder individually in the suspended state by electroacoustics.

A strength of greenbodies was determined by the Brazilian Disk Test (BDT). In the interior of the sample tensile stresses thus occur, which led to breakdown of the greenbody. A maximum tensile stress was calculated according to the following equation:

$${σ}_{BDT} = \frac{2 F}{D π t}$$

Here, F stands for the maximum force, D the diameter of the sample and t the thickness of the sample. Cylindrical samples with a diameter of 20 mm and a thickness of 10 mm were used.

### Example 1

### Porous Aluminum Oxide Ceramic

A ceramic suspension was produced in that deionized water with five molar HNO₃ solution was brought to a pH value of 4.2 to 4.5 and subsequently AlOOH powder with an average particle size (d₅₀) of 120 nm and Al₂O₃ powder with an average particle size (d₅₀) of 950 nm were suspended. In order to keep a pH value constant in the range of a viscosity minimum, a quantity of HNO₃ solution necessary for this was thereby added with the powders at the same time. The suspended powders had in the range of the viscosity minimum a zeta potential of +65 mV (AlOOH) or +49 mV (Al₂O₃). During the addition of the individual components the suspension was continuously deagglomerated, wherein the suspension was ground in circulation via an agitator ball mill. A very homogenous distribution of the powder particles in the suspension was achieved thereby and the coarse powder particles were largely enveloped by the finer powder particles. A proportion of the fine AlOOH powder in the powder mixture was 30 percent by volume. A solids content in the suspension after the production thereof was 58 percent by volume. A period of only two hours was necessary for the preparation of 1.5 liters of suspension.

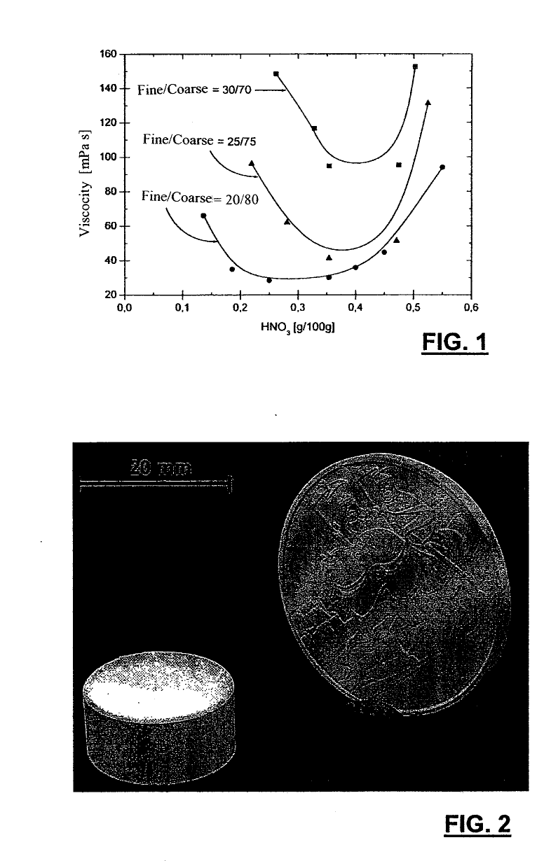

For the purpose of solidification, a small amount of aluminum nitride powder was added to the suspension. After the homogenization of the suspension, this was degassed under vacuum in order to remove any air pockets. At this time, the low-viscosity suspension had a viscosity (here, as below, at 20° C.) of 200 to 400 mPas. This low viscosity made it possible to pour off the suspension into non-porous plastic or metal molds despite a high solids content in the suspension, wherein differently shaped greenbodies were produced while retaining very fine structural details of the negative mold. A solidification of the suspension in the casting mold took place according to the reaction conditions within approx. one to six hours. A few hours after the pouring off, the greenbodies were demolded and subsequently dried. The greenbodies were characterized in the damp state by a high strength of approx. 28 to 300 kPa, which rendered possible an easy demolding and handling of the greenbodies even with very complicated geometries. Surface structures were thereby retained in every detail (see FIG. 2).

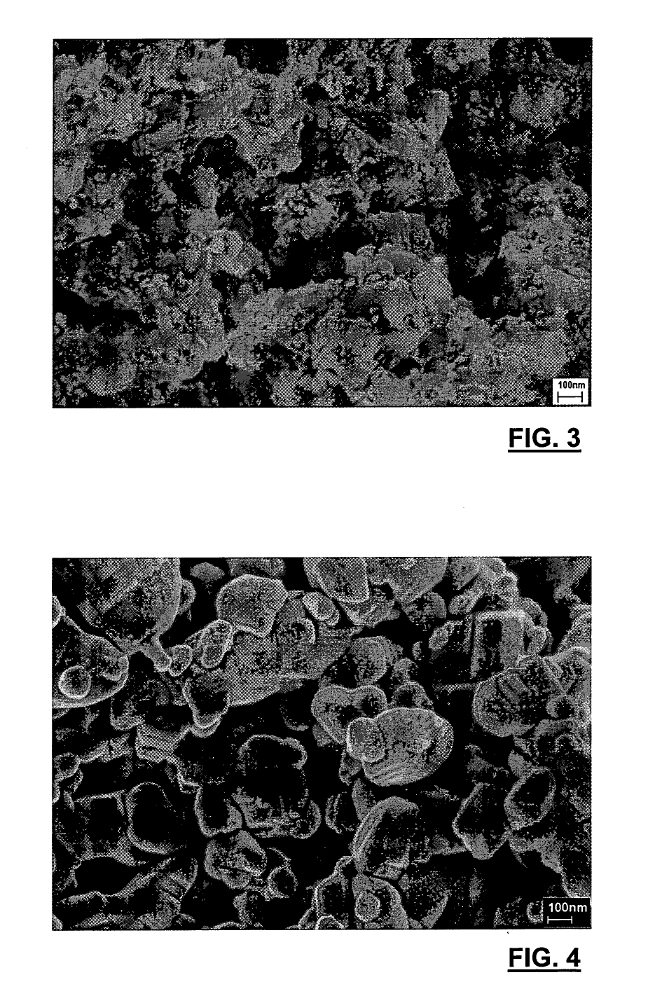

The greenbodies had a homogenous, largely defect-free and ordered structure. A structure of this type is shown in FIG. 3 by way of example based on a scanning electron microscope image. In this structure the coarse powder particles are largely enveloped by fine powder particles and firmly connected to one another, which leads to a high strength of the green molded article.

Greenbodies produced as described were sintered in a chamber furnace for eight hours isothermally at a temperature of 1300° C. in ambient atmosphere. A linear oscillation during sintering was less than 1.85 percent by volume. After the sintering, the ceramics comprised a stable α-Al₂O₃ phase. The ceramics typically had an open interconnective porosity of approx. 40 percent by volume and an average pore diameter of approx. 250 nm or less. As can be seen from FIG. 4 by way of example, the ceramics were characterized by an extremely homogenous, virtually defect-free structure and embodied essentially in a crack-free manner.

### Example 2

### Hierarchically Porous Zirconium Oxide

Analogously to example 1, a ceramic suspension was produced in the range of the viscosity minimum of the same from a finer ZrO₂ powder and a coarser ZrO₂ powder and with five molar HNO₃ solution at pH=3.6 to 3.8. The finer ZrO₂ powder was characterized in the range of the viscosity minimum by a zeta potential of +52 mV and the coarser ZrO₂ powder by a zeta potential of +39 mV. The particle sizes (d₅₀) were 90 nm or 1.2 μm, wherein a proportion of the finer powder in the powder mixture in the suspension was 20 percent by volume.

A granulate with an average diameter of approx. 0.8 millimeters was produced from a suspension produced in this manner with a solids content of 56 percent by volume. The dried granulate was pre-sintered isothermally in a chamber furnace for five hours at a temperature of 1200° C. in ambient atmosphere. After this treatment, the granulate had an open interconnective porosity and a high strength.

The pre-sintered granulate was subsequently added to a finely dispersed suspension, containing ZrO₂ powder with an average particle size of 90 nm, wherein the suspended solid typically comprised 90 percent by volume granulate and 10 percent finer ZrO₂ powder. A solids content in the suspension was adjusted to 58 percent by volume.

For solidification as well as for partial chemical stabilization of a tetragonal high temperature phase of ZrO₂ by Y₂O₃, a small amount of yttrium nitride powder (approx. one percent by volume) was added to the suspension. After the homogenization of the suspension, it was degassed under vacuum in order to remove any air pockets. At this time the low-viscosity suspension had a viscosity of 450 to 600 mPas and was poured off into non-porous plastic or metal molds. Within 30 minutes to approx. 3 hours, a solidification of the suspension in casting molds took place. The greenbodies were subsequently demolded in the damp state and dried. A high strength of approx. 42 to 450 kPa made it possible even with complicated geometries to demold easily while retaining structural details. As in example 1, the dried greenbodies were characterized by a very homogenous, virtually defect-free and ordered structure in which the coarser granulate particles were largely enveloped by the finer powder particles and firmly connected thereto.

Subsequently the greenbodies produced in this manner were sintered isothermally in a chamber furnace for eight hours at a temperature of 1250° C. A linear shrinkage was thereby approx. 1.4 percent by volume.

The essentially crack-free ceramics produced in this manner comprised a tetragonal ZrO₂ phase with a typically hierarchically structured open interconnective porosity of approx. 38 percent by volume. A pore size distribution was bimodal, wherein an average pore diameter of smaller pores was approx. 250 nm and an average pore diameter of larger pores was approx. 170 μm.

### Example 3

### SiC-Mullite Nanocomposite

A ceramic suspension was produced in the range of the viscosity minimum of the suspension (in that the pH value was adjusted to pH=3.7 to 3.9 and subsequently kept largely constant) through continuous addition of fine SiO₂ powder, fine AlOOH powder, coarse SiC powder and 5 molar HCl solution to produce an acid solution of a liquefier or additive with cationic action in water. The powders used were heavily agglomerated or aggregated in the dry state. In the range of the viscosity minimum the powders had zeta potentials of +57 mV (SiO₂), +68 mV (AlOOH) and +42 mV (SiC). The average powder sizes were 66 nm (SiO₂), 59 nm (AlOOH) or 550 nm (SiC). This shows that through the use of a cationic liquefier (e.g., a polyelectrolyte or a surfactant) even with normally negatively charged particle surfaces (SiC) positive zeta potentials can be adjusted or an identical zeta potential with respect to the sign (positive or negative) can be adjusted for all powders.

During the addition of the suspension components the suspension was continuously deagglomerated in that the suspension was pumped in circulation via an agitator ball mill. A very homogenous distribution of the powder particles was hereby achieved in the suspension, wherein the coarse powder particles were largely enveloped by the fine powder particles or bonded thereto. A solids content of the suspension was 54 percent by volume after the production. The proportion of the fine powder in the powder mixture was typically 10 to 30 percent by volume.

For the purpose of solidification, a small amount of AlN powder was added to the suspension. After the homogenization of the suspension, it was degassed under vacuum in order to remove any air pockets. At this time the low-viscosity suspension had a viscosity of 500 to 900 mPas. By pouring off the suspension into non-porous plastic or metal molds, differently shaped greenbodies were produced. The solidification of the suspension in the casting mold took place depending on the reaction conditions within approx. 30 minutes to 5 hours. The greenbodies were demolded in the damp state a few hours after pouring off and subsequently dried.

In the damp state the greenbodies had a strength of 23 to 260 kPa. In the dried state the greenbodies were characterized by a very homogenous virtually defect-free and ordered structure in that the coarse powder particles were largely enveloped by the fine powder particles and firmly connected thereto. A proportion of organic components (resulting from the cationic liquefier) in the greenbody was less than 1.2 percent by weight.

The greenbodies produced in this manner were densely sintered isothermally in a furnace for 3 hours at a temperature of 1600° C. in an inert atmosphere. Mullite was thereby formed from the fine powders. The essentially crack-free dense ceramic was characterized by a very homogenous, virtually defect-free structure, wherein the two phases were arranged such that mullite preferably surrounded the SiC grains and formed a largely continuous border typically with a thickness of approx. 80 to 120 nanometers. This shows that the finer powders can be used for the targeted adjustment or modification of grain boundaries, whereby a control of functional and mechanical properties of ceramics is given.

### Example 4

### Ceramic Matrix Composite with Mullite

A ceramic suspension was produced in the range of the viscosity minimum of the suspension (in that the pH value was largely kept constant between 3.8 to 4.2) through the continuous addition of fine SiO₂ powder, fine AlOOH powder, coarse mullite powder and 5 molar HNO₃ solution to form an aqueous solution of a liquefier with cationic action. The powders used were heavily agglomerated or aggregated in the dry state. The fine SiO₂ powder was characterized by a zeta potential of +55 mV in the range of the viscosity minimum. An average particle size (d₅₀) was 65 nanometers; the fine AlOOH powder was characterized by a zeta potential of +62 mV in the range of the viscosity minimum. An average particle size (d₅₀) was 55 nanometers; the coarse mullite powder was characterized in the range of the viscosity minimum by a zeta potential of +45 mV. An average particle size (d₅₀) was 710 nanometers.

During the addition of the suspension components, the suspension was continuously deagglomerated in that the suspension was pumped in circulation via an agitator ball mill. A very homogenous distribution of the powder particles was hereby achieved in the suspension, wherein the coarse powder particles were largely enveloped by the fine powder particles or the fine powder particles were bonded to the coarse particles. The solids content of the suspension after production was 51 percent by volume. The proportion of the fine powder in the powder mixture was typically 10 to 30 percent by volume.

For the purpose of solidification, a small amount of AlN powder was added to the suspension. After homogenization of the suspension, it was degassed under vacuum in order to remove any air pockets. At this time the low-viscosity suspension had a viscosity of 150 to 280 mPas. Simply shaped composite ceramic components were produced in that several fabric layers of oxidic fibers (Nextel 720; 3M Ceramic Textiles and Composites, St. Paul, Minn., USA) were individually infiltrated with the suspension and placed in a plastic or metal mold. The composite molded articles thus obtained were compacted by way of a vacuum bag and demolded after approx. 12 hours.

For the production of composite ceramic components with complicated shapes, several fabric layers of oxidic fibers (Nextel 720; 3M Ceramic Textiles and Composites, St. Paul, Minn., USA) were individually infiltrated with the suspension and subsequently sprayed with a non-aqueous mullite sol (precursor) that gave the fabric layers a high adhesiveness. The fabric layers were laminated in a plastic or metal mold, compacted by way of a vacuum bag and demolded after approx. 12 hours.

The dried laminates were characterized by a very homogenous and ordered structure, wherein in the matrix the coarse powder particles were largely enveloped by the fine powder particles and firmly connected thereto. A proportion of organic components (resulting from the cationic liquefier) in the composite article was less than 1.2 percent by weight. The laminates were characterized by an excellent sintering behavior and a high strength.

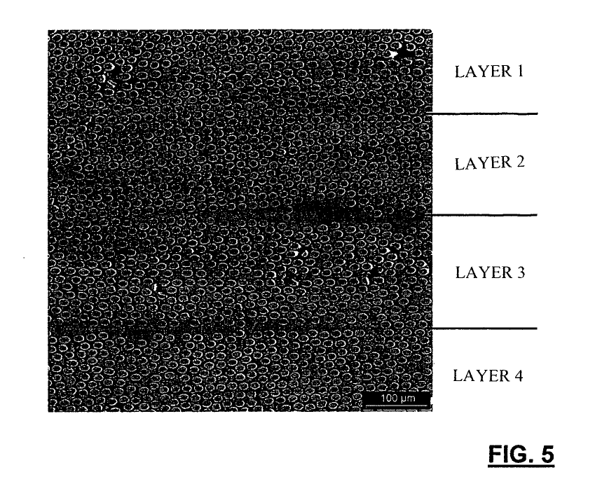

The laminates produced in this manner were sintered in a furnace for 10 hours at temperatures between 1200 to 1350° C. in a normal atmosphere. The fine powder was thereby compacted virtually completely in a first step and in a second step formed crystalline mullite. A linear shrinkage of the matrix was less than 1.8 percent. A fiber proportion of the ceramic was typically 52 to 55 percent by volume (see FIG. 5), a porosity 17 to 20 percent by volume. The composite ceramic was characterized by a homogenous structure with very low state of internal stress, as well as excellent mechanical characteristic values and an excellent high-temperature stability. The mechanical behavior was virtually unchanged even after high-temperature aging over 1000 hours up to 1250° C.

Advantages of a composite part of this type are a low-defect matrix state in combination with a high fiber volume proportion. This leads in general to higher mechanical characteristic values, above all also in matrix-dominated stress situations (e.g., with tensile stress or shearing stress at ±45° to the fiber axes), which hitherto was a clear weak point of composite ceramics of this type.

### Example 5

### Ceramic Matrix Composite in the Infusion Method

A suspension was produced as in example 4. The solids content in the suspension after its production was 48 percent by volume. A proportion of the fine powder in the powder mixture was typically 10 to 30 percent by volume. For the purpose of solidification, a small amount of AlN powder was added to the suspension. After homogenization of the suspension, it was degassed under vacuum in order to remove any air pockets. At this time the very low-viscosity suspension had a viscosity of 80 to 170 mPas.

Textile preforms of carbon fibers with 3-dimensional reinforcement architecture were placed in a mold and infiltrated with the suspension by the infusion method. After the solidification, the laminates were demolded and sintered in an inert atmosphere at temperatures as in Example 4. The composite ceramic was characterized by a homogenous structure with low-defect matrix structure and 3-dimensional reinforcement architecture.

It was thus shown that, based on the low viscosities achievable, a suspension can also be used for infiltration of 3-dimensional fiber preforms, which are becoming increasingly important due to the superior mechanical characteristic values. In addition, infusion methods are more economic and can be better reproduced than laminating methods.

### Example 6

### Al₂O₃—SiC Nanocomposite

A ceramic suspension was produced in the range of the viscosity minimum of the suspension (in that the pH value was kept largely constant between 4.0 and 4.4) through continuous addition of fine SiC powder, fine AlOOH powder, coarse Al₂O₃ powder and 5 molar HNO₃ solution to produce an acid aqueous solution of a liquefier with cationic action. The powders used were strongly agglomerated or aggregated in the dry state. In the range of the viscosity minimum the fine SiC powder was characterized by a zeta potential of +50 mV (average particle size (d₅₀) of 150 nm). In the range of the viscosity minimum the fine AlOOH powder was characterized by a zeta potential of +65 mV (average particle size (d₅₀) of 59 nm). The coarse Al₂O₃ powder in the range of the viscosity minimum was characterized by a zeta potential of +45 mV (average particle size (d₅₀) of 350 nm).

During the addition of the suspension components, the suspension was continuously deagglomerated, in that the suspension was pumped in circulation via an agitator ball mill. A very homogenous distribution of the powder particles in the suspension was achieved hereby, wherein the coarse powder particles were largely enveloped by the fine powder particles. A solids proportion of the suspension was 54 percent by volume after the production thereof. A proportion of the fine powder in the powder mixture was typically 10 to 30 percent by volume. After homogenization of the suspension, it was degassed under vacuum in order to remove any air pockets. At this time the suspension had a viscosity of 500 to 900 mPas.

For the continuous shaping of greenbodies, the suspension was extruded through a nozzle, wherein for the purpose of a rapid solidification a small amount of polysilazane (˜1 percent by volume) was added to the suspension immediately prior to the extrusion. The solidification took place depending on the reaction conditions within several minutes up to one hour. The greenbodies were characterized by a high strength, which made easy handling possible. The dried greenbodies were further characterized by a very homogenous, virtually defect-free and ordered structure, in that the coarse powder particles were largely enveloped by the fine powder particles and firmly connected thereto. The greenbodies were further characterized by an excellent sintering behavior and a high strength.

The greenbodies produced in this manner were sintered isothermally in a furnace for 2 hours at a temperature of 1800° C. in an inert atmosphere to a relative density of 99.5%. A nanocomposite with nanoscale interphases and intraphases is formed thereby from SiC in an Al₂O₃ matrix. The polysilazane thereby likewise formed nanoscale SiCO or SiCNO dispersoids. The essentially dense ceramic was characterized by a very homogenous, virtually defect-free structure and excellent strength and toughness (through structure reinforcement with nano-dispersoids) and high-temperature resistance.

Advantages of this use according to the invention are that due to the relatively quick solidification by polysilazane, plastic shaping methods such as extrusion can also be used. The polysilazane increases the green strength compared to AlN, since not only is ammonia formed, but a crosslinking reaction also takes place. The crosslinked polysilazane further contributes during sintering to the reinforcement of the structure through the formation of nano-dispersoids.

1.-23. (canceled)

24. A method for producing a molded ceramic article comprising:
suspending a powder A and at least one further powder B a liquid to form a suspension; and
forming a molded article from the suspension,
wherein liquid into which the powder A and the at least one further powder B are suspended has an approximate pH value for a viscosity minimum for the suspension.

25. The method in accordance with claim 24, wherein molded ceramic article comprises a porous molded ceramic article.

26. The method in accordance with claim 24, wherein the formed molded article is reinforced with at least one of fibers, a semi-finished textile product, and a woven fabric, and
wherein the molded article is sintered.

27. The method in accordance with claim 24, further comprising, while forming the suspension, adjusting the approximate pH value to maintain an adjusted pH value for the viscosity minimum for the suspension

28. The method in accordance with claim 27, wherein zeta potentials of the suspended powders have a same sign at the adjusted pH value.

29. The method in accordance with claim 27, further comprising adding an additive to the suspension, which is adsorbed on at least one of the powders,
wherein the additive comprises a peptizer or polyelectrolyte.

30. The method in accordance with claim 24, wherein the powder A and the at least one further powder B have different average grain sizes.

31. The method in accordance with claim 24, wherein an average grain size of the powder A is at least four times that of the at least one further powder B.

32. The method in accordance with claim 24, wherein the powder A has an average grain size of more than 300 nm and the at least one further powder B has an average grain size of less than 100 nm.

33. The method in accordance with claim 30, wherein a volume ratio of the powder A to the at least one further powder B is 0.65:0.35 to 0.90:0.10.

34. The method in accordance with claim 24, wherein during the suspension of the powders, the method further comprises grinding the liquid and the powders.

35. The method in accordance with claim 24, wherein during the suspension of the powders, the method further comprises acting on the liquid and the powders with ultrasound.

36. The method in accordance with claim 24, wherein a percentage by volume of the powders in the suspension is more than 50% by volume.

37. The method in accordance with claim 36, wherein the percentage by volume of the powders in the suspension is more than 55% by volume.

38. The method in accordance with claim 24, wherein the liquid is water.

39. The method in accordance with claim 24, further comprising adding a hardener to the suspension before forming the molded article.

40. The method in accordance with claim 39, wherein the hardener causes a shift of the pH value towards an isoelectric point and forms a solid reaction product with the liquid.

41. The method in accordance with claim 39, wherein the hardener is a metal nitride comprising one of magnesium nitride, gallium nitride, lanthanum nitride, zirconium nitride, aluminum nitride, yttrium nitride or hafnium nitride.

42. The method in accordance with claim 39, wherein the hardener is an organosilicon polymer comprising one of polysilazane, polycarbosilazane, polysilasilazane or polysilylcarbodiimide.

43. A molded article formed in accordance with claim 24, wherein the article is free of fibers.

44. The molded article in accordance with claim 43 having a structure in which particles of the powder A are largely enveloped by, and firmly connected to, particles of the powder B.

45. The molded article according to claim 44, wherein a maximum defect size in the structure is smaller than a maximum grain size of the powders.

46. The molded article in accordance with claim 43, wherein the molded article is porous and has one of a bimodal or multimodal pore size distribution.

47. A composite article comprising:
ceramic; and
at least one of fibers, a textile semi-finished product, and a woven fabric,
wherein a proportion of the at least one of the fibers, textile semi-finished product, and the woven fabric is more than 50 percent by volume.

48. The composite article in accordance with claim 47 having a structure in which particles of a powder A are largely enveloped by, and connected to, particles of at least one powder B.

49. The composite article in accordance with claim 47, wherein a maximum defect size in the structure is less than a maximum grain size of the powders.

50. The composite article in accordance with claim 47, wherein the ceramic is porous and has one of a bimodal or multimodal pore size distribution.
